(19) United States
(12) Patent Application Publication
(10) Pub. No.: US 2026/0142264 A1
(43) Pub. Date: May 21, 2026

(54) ELECTRIFIED VEHICLE

(71) Applicant: TOYOTA JIDOSHA KABUSHIKI KAISHA, Toyota-shi (JP)

(72) Inventor: Koji NAKANISHI, Nagakute-shi (JP)

(73) Assignee: TOYOTA JIDOSHA KABUSHIKI KAISHA, Toyota-shi (JP)

(21) Appl. No.: 19/329,893

(22) Filed: Sep. 16, 2025

(30) Foreign Application Priority Data
Nov. 20, 2024 (JP) 2024-202626

(51) Int. Cl. H01M 10/633; B60H 1/00; B60L 58/26; H01M 10/613; H01M 10/625; H01M 10/663

(52) U.S. Cl. CPC H01M 10/633; B60H 1/00278; B60H 1/00878; B60L 58/26; H01M 10/613; H01M 10/625; H01M 10/663; B60L 2260/56; H01M 2220/20

(57) ABSTRACT

An electrified vehicle includes a temperature adjustment control device, in which the temperature adjustment control device is configured to predict a predicted battery temperature adjustment time needed for a temperature of the battery to be a temperature suitable for charging through the temperature adjustment by the air conditioner, when the vehicle arrives at a destination set by the navigation system, based on the destination and a current location, and store a difference between the predicted battery temperature adjustment time and an actual time actually needed for the temperature adjustment by the air conditioner as an actual predicted time difference.

### CROSS-REFERENCE TO RELATED APPLICATION

This application claims priority to Japanese Patent Application No. 2024-202626 filed on Nov. 20, 2024. The disclosure of the above-identified application, including the specification, drawings, and claims, is incorporated by reference herein in its entirety.

### BACKGROUND

### 1. Technical Field

The present disclosure relates to an electrified vehicle, and particularly, to an electrified vehicle in which a battery can be temperature-adjusted by an air conditioner that air-conditions a cabin.

### 2. Description of Related Art

The following electrified vehicles of this type have been proposed. That is, an electrified vehicle has been proposed in which, when the battery is chargeable after the electrified vehicle moves to a destination, the temperature of the battery is controlled to be within a temperature range suitable for charging (for example, see Japanese Unexamined Patent Application Publication No. 2024-113797 (JP 2024-113797 A)). In the electrified vehicle, the temperature of the battery is set to the temperature range suitable for charging when the electrified vehicle arrives at the destination, so that a charging time is suppressed from being long.

### SUMMARY

However, in the electrified vehicle described above, it is needed to predict a time (predicted battery temperature adjustment time) needed to adjust the temperature of the battery to the temperature range suitable for charging when the electrified vehicle arrives at the destination. In a case where the predicted battery temperature adjustment time is short with respect to the actual time needed to set the temperature of the battery to the temperature range suitable for charging, the temperature of the battery cannot be set to the temperature range suitable for charging in many cases. On the other hand, in a case where the predicted battery temperature adjustment time is long with respect to the actual time, the temperature of the battery can be set to the temperature range suitable for charging, but the battery is temperature-adjusted using excessive energy. Therefore, there is a need to improve the accuracy of the predicted battery temperature adjustment time.

A main object of an electrified vehicle of the present disclosure is to contribute to improving the accuracy of a predicted battery temperature adjustment time required to perform temperature adjustment of a battery to set the temperature of the battery to a temperature range suitable for charging when the electrified vehicle arrives at a destination.

The electrified vehicle according to the present disclosure is configured as follows.

An electrified vehicle of the present disclosure includes:
an electric motor configured to input and output power for traveling;
a battery configured to exchange electric power with the electric motor;
an air conditioner configured to perform air conditioning of a cabin and temperature adjustment of the battery;
a navigation system; and
a temperature adjustment control device configured to control the temperature adjustment of the battery.
   The temperature adjustment control device is configured to predict a predicted battery temperature adjustment time needed for a temperature of the battery to reach a temperature suited for charging through the temperature adjustment by the air conditioner, when the electrified vehicle arrives at a destination set by the navigation system, based on the destination and a current location, and store a difference between the predicted battery temperature adjustment time and an actual time actually needed for the temperature adjustment by the air conditioner as an actual predicted time difference.

In the electrified vehicle according to the present disclosure, the predicted battery temperature adjustment time is predicted based on the destination set by the navigation system and the current location. The predicted battery temperature adjustment time is the time needed for the temperature of the battery to reach the temperature suited for charging through the temperature adjustment by the air conditioner when the vehicle arrives at the destination. Then, the difference between the predicted battery temperature adjustment time and the actual time actually needed for the temperature adjustment by the air conditioner is stored as the actual predicted time difference. In this way, the prediction of the predicted battery temperature adjustment time is performed such that the stored actual predicted time difference (difference between the predicted battery temperature adjustment time and the actual time) is reduced, whereby the accuracy of the predicted battery temperature adjustment time can be improved. As described above, by storing the actual predicted time difference (difference between the predicted battery temperature adjustment time and the actual time), the accuracy of the predicted battery temperature adjustment time can be improved.

In the electrified vehicle according to the present disclosure, the temperature adjustment control device may be configured to calculate the predicted battery temperature adjustment time each time a predetermined time elapses after the temperature adjustment by the air conditioner is started, calculate an expected time predetermined time difference obtained by subtracting the predicted battery temperature adjustment time that is currently calculated and the predetermined time from the predicted battery temperature adjustment time calculated in previous calculation each time the predetermined time elapses, and store a maximum value of the expected time predetermined time difference calculated each time the predetermined time elapses as the actual predicted time difference. In this way, the maximum value of the expected time predetermined time difference calculated every time the predetermined time elapses in the middle of the temperature adjustment of the battery by the air conditioner can be stored. Then, the maximum value of the expected time predetermined time difference can be used to improve the accuracy of the predicted battery temperature adjustment time.

In the electrified vehicle according to the present disclosure, the temperature adjustment control device may be configured to distinguish between the actual predicted time difference when the air conditioner has performed the temperature adjustment of the battery in a state where the air conditioner performs air conditioning of the cabin and the actual predicted time difference when the air conditioner has performed the temperature adjustment of the battery in a state where the air conditioner does not perform air conditioning of the cabin, and store the actual predicted time difference. By distinguishing between the state in which the air conditioning of the cabin is performed and the state in which the air conditioning of the cabin is not performed, the accuracy of the predicted battery temperature adjustment time predicted in each state can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an outline of a configuration of an electrified vehicle as an embodiment of the present disclosure; and

FIG. 2 is a flowchart showing an example of the actual predicted difference time storing process executed by the electronic control unit.

### DETAILED DESCRIPTION OF EMBODIMENTS

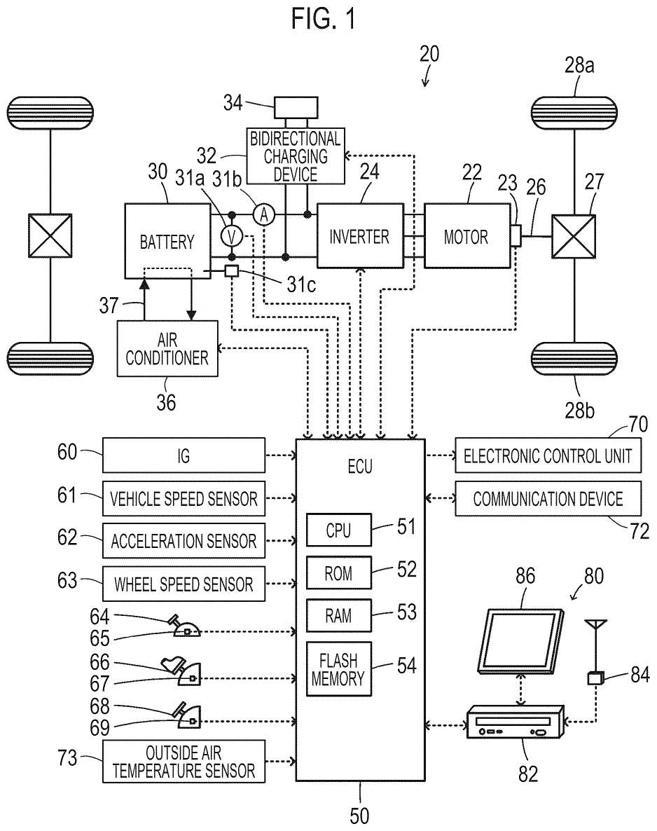

Next, an embodiment for implementing the present disclosure will be described. FIG. 1 is a configuration diagram showing an outline of a configuration of an electrified vehicle 20 as an embodiment of the present disclosure. The electrified vehicle 20 of the embodiment includes a motor 22, an inverter 24, a battery 30, a bidirectional charging device 32, an air conditioner 36, a navigation device 80, and an electronic control unit 50 as shown in the drawing.

The motor 22 is configured as, for example, a three-phase alternating current motor, and includes a rotor in which a permanent magnet is embedded in a rotor core and a stator in which three-phase coils are wound around a stator core. The rotor of the motor 22 is connected to a drive shaft 26 connected to the drive wheels 28a, 28b via a differential gear 27.

The inverter 24 is used to drive the motor 22. The inverter 24 is connected to the battery 30 via an electric power line. The inverter 24 is configured by a well-known inverter circuit having six transistors as switching elements and six diodes connected in parallel to the six transistors, respectively.

The battery 30 is configured as a lithium ion secondary battery or a nickel hydrogen secondary battery, and is connected to the inverter 24 via an electric power line.

The bidirectional charging device 32 is connected to an electric power line between the battery 30 and the inverter 24, and is configured as a circuit that charges the battery 30 with electric power from an external power supply or supplies electric power of the battery 30 to an external power feeder. The bidirectional charging device 32 is attached with a connector 34 for connecting to an external charging stand or an external power supply stand.

The air conditioner 36 performs air conditioning of the cabin and exchanges heat with the battery 30 by flowing the heat exchange medium into a circulation flow path 37 with the battery 30, and adjusts the temperature of the battery 30 by heating or cooling the battery 30.

The electronic control unit 50 is configured as a microcomputer having a CPU 51, a ROM 52, a RAM 53, a flash memory 54, an input and output port (not shown), and a communication port (not shown). Signals from various sensors are input to the electronic control unit 50 via input ports. Examples of the signal input to the electronic control unit 50 include a rotation position θ from a rotation position detection sensor 23 that detects a rotation position of a rotor of the motor 22. Examples of the signal input to the electronic control unit 50 include a battery voltage Vb from a voltage sensor 31a attached between the output terminals of the battery 30. Examples of the signal input to the electronic control unit 50 include a battery current Ib from the current sensor 31b attached to the electric power line. Examples of the signal input to the electronic control unit 50 include the battery temperature Tb from the temperature sensor 31c attached to the battery 30. An ignition signal from an ignition switch 60, a vehicle speed V from the vehicle speed sensor 61, an acceleration α from an acceleration sensor 62, and wheel speeds Vw1 to Vw4 of the respective wheels from a wheel speed sensor 63 can also be included. In addition, a shift position signal SP from a shift position sensor 65 that detects a position of the shift lever 64, an accelerator operation amount Acc from an accelerator pedal position sensor 67 that detects a depression amount of an accelerator pedal 66, and the like can also be included. In addition, a brake pedal position BP from a brake pedal position sensor 69 that detects a depression amount of a brake pedal 68 can also be included. Further, an outside air temperature Tout from the outside air temperature sensor 73 and an on/off signal from an air conditioning switch (not shown) that instructs the on/off of the air conditioner 36 can also be included.

Various control signals are output from the electronic control unit 50 via output ports. Examples of the control signal output from the electronic control unit 50 include a display control signal to a display device 70, a communication control signal to a communication device 72, an air conditioning control signal or a temperature adjustment control signal to the air conditioner 36, and the like. The electronic control unit 50 calculates the state of charge SOC of the battery 30 based on the battery voltage Vb from the voltage sensor 31a or the battery current Ib from the current sensor 31b. The electronic control unit 50 calculates the rotation speed Nm of the motor 22 based on the rotation position θ from a rotation position detection sensor 23.

The navigation device 80 includes a main body 82 in which a controller is built in, a GPS antenna 84 that receives information on a current location of the host vehicle, and a display 86. The controller of the main body 82 has a storage medium (for example, a hard disk or an SSD) in which map information or the like is stored, an input and output port, and a communication port. The map information includes service information (for example, sightseeing information or a parking lot) and road information of each traveling section (for example, between traffic lights or between intersections) stored as a database. The road information includes distance information, width information, the number of lanes information, area information (urban area or suburb), type information (general road or expressway), gradient information, a legal speed, the number of traffic lights, and a turning radius of each curve. The display 86 is configured to display various pieces of information such as information regarding the current location of the host vehicle and a scheduled travel route to the destination, and is a touch panel type display in which the user can input various instructions. When the destination is set by the user operating the display 86, the main body 82 of the navigation device 80 sets the scheduled travel route from the current location of the host vehicle to the destination. The scheduled travel route is set based on the map information stored in the main body 82, the current location of the host vehicle, and the destination from the GPS antenna 84. The main body 82 of the navigation device 80 displays the set scheduled travel route on the display 86 and performs route guidance.

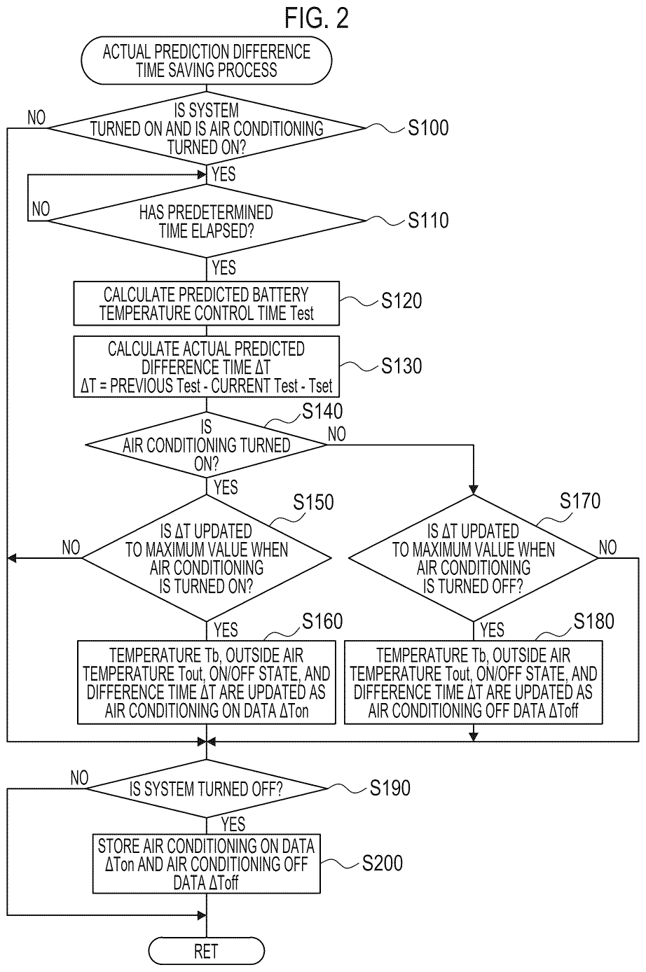

Next, the operation of the electrified vehicle 20 of the embodiment configured as described above will be described. In particular, an operation for storing the actual predicted difference time ΔT will be described. The actual predicted difference time ΔT is a difference time between the predicted battery temperature adjustment time Test for performing the temperature adjustment of the battery 30 to set the temperature Tb of the battery 30 within the temperature range suitable for charging of the battery 30 when the electrified vehicle arrives at a destination and the actual time. FIG. 2 is a flowchart showing an example of the actual predicted difference time storing process executed by the electronic control unit 50. The process is executed each time the predetermined time Tset elapses after the temperature adjustment of the battery 30 by the air conditioner 36 is started Test before the predicted battery temperature adjustment time Test from a predicted arrival time at the destination.

When the actual predicted time difference storing process is executed, the electronic control unit 50 first confirms that the system is turned on and the temperature adjustment of the battery 30 by the air conditioner 36 is turned on (S100). Wait for the predetermined time Tset to elapse (S110). When the predetermined time Tset elapses, the predicted battery temperature adjustment time Test is calculated (S120). The predicted battery temperature adjustment time Test is stored based on, for example, the temperature Tb of the battery 30, the outside air temperature Tout, the on/off state of the air conditioning of the cabin, and the like when the temperature adjustment of the battery 30 is started by the air conditioner 36. The predicted battery temperature adjustment time Test is stored in advance as a predicted battery temperature adjustment time setting map by obtaining a relationship between the temperature Tb of the battery 30, the outside air temperature Tout, the on/off state of the air conditioning of the passenger cabin, and the predicted battery temperature adjustment time Test by experiments, machine learning, or the like. The predicted battery temperature adjustment time Test can be obtained by deriving the corresponding predicted battery temperature adjustment time Test from the map when the temperature Tb of the battery 30, the outside air temperature Tout, and the on/off state of the air conditioning of the cabin are given.

When the predicted battery temperature adjustment time Test is calculated, the predicted battery temperature adjustment time Test calculated this time is subtracted from the predicted battery temperature adjustment time Test calculated last time, and a predetermined time Tset is subtracted. As a result, the actual predicted difference time ΔT (ΔT=the previous Test−the current Test−Tset) is calculated (S130). Then, it is determined whether the air conditioner 36 is turned on (S140). When determination is made that the air conditioning of the cabin by the air conditioner 36 is turned on, the process proceeds to S150. A determination is made whether the actual predicted difference time ΔT calculated this time is the maximum value among the actual predicted difference times ΔT calculated when the determination is made that the air conditioning of the cabin by the air conditioner 36 is turned on (S150). When determination is made that the actual predicted difference time ΔT calculated this time is the maximum value among the actual predicted difference times ΔT calculated so far, the process proceeds to S160. The temperature Tb of the battery 30, the outside air temperature Tout, the on/off state of the air conditioning of the cabin, and the actual predicted difference time ΔT are updated as the air conditioning on data ΔTon (S160). When determination is made that the actual predicted difference time ΔT calculated this time is not the maximum value among the actual predicted difference times ΔT calculated so far, the update of the air conditioning on data ΔTon is not performed.

When determination is made in S140 that the air conditioning of the cabin by the air conditioner 36 is off, the process proceeds to S170. A determination is made whether the actual predicted difference time ΔT calculated this time is the maximum value among the actual predicted difference times ΔT calculated when the determination is made that the air conditioning of the cabin by the air conditioner 36 is turned off (S170). When determination is made that the actual predicted difference time ΔT calculated this time is the maximum value among the actual predicted difference times ΔT calculated so far, the process proceeds to S180. The temperature Tb of the battery 30, the outside air temperature Tout, the on/off state of the air conditioning of the cabin, and the actual predicted difference time ΔT are updated as the air conditioning off data ΔToff (S180). When determination is made that the actual predicted difference time ΔT calculated this time is not the maximum value among the actual predicted difference times ΔT calculated so far, the update of the air conditioning off data ΔToff is not performed.

Next, it is determined whether the system is turned off (S190), and when it is determined that the system is turned off, the air conditioning on data ΔTon and the air conditioning off data ΔToff are stored (S190), and the present process ends. The air conditioning on data ΔTon and the air conditioning off data ΔToff stored here are maximum values of the actual predicted difference times ΔT calculated every time a predetermined time Tset elapses until the temperature adjustment of the battery 30 by the air conditioner 36 is completed. When determination is made in S190 that the system is not turned off, the present process is terminated without storing the air conditioning on data ΔTon or the air conditioning off data ΔToff.

In the electrified vehicle 20 according to the embodiment described above, the following processing is executed when the air conditioning of the cabin by the air conditioner 36 is turned on or when the air conditioning of the cabin by the air conditioner 36 is turned off. That is, the actual predicted difference time ΔT is calculated by subtracting the predicted battery temperature adjustment time Test calculated this time from the predicted battery temperature adjustment time Test calculated last time at a predetermined time from the predetermined time Tset. Then, the maximum value is stored as air conditioning on data ΔTon or air conditioning off data ΔToff together with the temperature Tb of the battery 30, the outside air temperature Tout, and the on/off state of the air conditioning of the cabin. The obtained air conditioning on data ΔTon and the air conditioning off data ΔToff can be used to more appropriately calculate the predicted battery temperature adjustment time Test, and thus the accuracy of the predicted battery temperature adjustment time Test can be improved.

In the electrified vehicle 20 of the embodiment, the actual predicted difference time ΔT is calculated by subtracting the predicted battery temperature adjustment time Test calculated this time from the predicted battery temperature adjustment time Test calculated last time at a predetermined time from the predetermined time Tset. Then, the maximum value is stored as air conditioning on data ΔTon or air conditioning off data ΔToff together with the temperature Tb of the battery 30, the outside air temperature Tout, and the on/off state of the air conditioning of the cabin. However, the difference time between the predicted battery temperature adjustment time Test and the actual time may be stored as the air conditioning on data ΔTon or the air conditioning off data ΔToff together with the temperature Tb of the battery 30, the outside air temperature Tout, and the on/off state of the air conditioning of the cabin at the time of the start of the temperature adjustment. The predicted battery temperature adjustment time Test is calculated before the air conditioner 36 starts the temperature adjustment of the battery 30. The real time is the time actually needed for the temperature adjustment of the battery 30 by the air conditioner 36.

The correspondence between the main elements of the embodiment and the main elements of the disclosure described in the column of the means for solving the problems will be described. In the embodiment, the motor 22 is an example of an “electric motor”, the battery 30 is an example of a “battery”, and the air conditioner 36 is an example of an “air conditioner”. The navigation device 90 is an example of a “navigation system”, and the electronic control unit 50 is an example of a “temperature adjustment control device”.

The correspondence between the main elements of the embodiment and the main elements of the disclosure described in the column of means for solving the problem is an example for specifically describing the embodiment for implementing the disclosure described in the column of means for solving the problem. Therefore, the elements of the disclosure described in the column of the means for solving the problem are not limited. That is, the interpretation of the disclosure described in the column of the means for solving the problem should be made based on the description in the column, and the embodiment is merely a specific example of the disclosure described in the column of the means for solving the problem.

Although the embodiment for implementing the above-described disclosure has been described, the above-described disclosure is not limited to the embodiment, and can be implemented in various forms within the scope of the spirit of the above-described disclosure.

The present disclosure can be used in the manufacturing industry of electrified vehicles.

What is claimed is:

1. An electrified vehicle comprising:
an electric motor configured to input and output power for traveling;
a battery configured to exchange electric power with the electric motor;
an air conditioner configured to perform air conditioning of a cabin and temperature adjustment of the battery;
a navigation system; and
a temperature adjustment control device configured to control the temperature adjustment of the battery,
wherein the temperature adjustment control device is configured to predict a predicted battery temperature adjustment time needed for a temperature of the battery to reach a temperature suited for charging through the temperature adjustment by the air conditioner, when the electrified vehicle arrives at a destination set by the navigation system, based on the destination and a current location, and store a difference between the predicted battery temperature adjustment time and an actual time actually needed for the temperature adjustment by the air conditioner as an actual predicted time difference.

2. The electrified vehicle according to claim 1, wherein the temperature adjustment control device is configured to calculate the predicted battery temperature adjustment time each time a predetermined time elapses after the temperature adjustment by the air conditioner is started, calculate an expected time predetermined time difference obtained by subtracting the predicted battery temperature adjustment time that is currently calculated and the predetermined time from the predicted battery temperature adjustment time calculated in previous calculation each time the predetermined time elapses, and store a maximum value of the expected time predetermined time differences calculated each time the predetermined time elapses as the actual predicted time difference.

3. The electrified vehicle according to claim 2, wherein the temperature adjustment control device is configured to distinguish between the actual predicted time difference when the air conditioner has performed the temperature adjustment of the battery in a state where the air conditioner performs air conditioning of the cabin and the actual predicted time difference when the air conditioner has performed the temperature adjustment of the battery in a state where the air conditioner does not perform air conditioning of the cabin, and store the actual predicted time difference.
